(19) United States
(12) Patent Application Publication
(10) Pub. No.: US 2026/0359687 A1
(43) Pub. Date: Nov. 12, 2026

(54) Artificial Intelligence-Enhanced Resource Allocation Systems Using Photonic Quantum Computing for Carbon Efficiency

(71) Applicant: Bank of America Corporation, Charlotte, NC (US)

(72) Inventors: Shiva Prasad S, Chennai, IN (US); Krithika Viswanathan, Chennai, IN (US); Amit Mishra, Chennai, IN (US); Shailendra Singh, Thane West, Maharashtra, IN (US); Subburathinam Krishnan, Chennai, IN (US)

(21) Appl. No.: 18/586,897

(22) Filed: Feb. 26, 2024

(51) Int. Cl. G06N 10/20; G06N 10/60

(52) U.S. Cl. CPC G06N 10/20; G06N 10/60

(57) ABSTRACT

Systems and methods for dynamic resource allocation in digital environments are disclosed and designed to maximize efficiency and minimize the environmental impact of computing operations. Leveraging the synergistic capabilities of artificial intelligence (AI) and Photonic Quantum Computing, the system intelligently predicts user demands and evaluates various resource allocation strategies for their carbon efficiency. It incorporates natural language processing for demand prediction, machine learning for continuous improvement, and a Quantum Computing module for strategy simulation. An energy management module reduces power consumption in real-time and a user analytics module provides insights into sustainable digital practices. This approach not only enhances the user experience by ensuring high responsiveness and service quality but also advances environmental sustainability goals by optimizing the carbon footprint of digital services. The system represents a significant step forward in the field of computing, offering a model for future developments in sustainable and efficient digital resource management.

### TECHNICAL FIELD

The present disclosure relates to data processing-artificial intelligence (AI) and, more particularly, to development and implementation of AI and Quantum Computing technologies to dynamically allocate digital resources in an environmentally sustainable manner, including novel use of Photonic Quantum Computing for real-time, efficient, and carbon-conscious decision-making in digital interactions. AI systems and methods for processing, understanding, and responding to user interactions, as well as the optimization of resource allocation to minimize carbon footprints, are disclosed.

### DESCRIPTION OF THE RELATED ART

In the current digital environment, users engage with an extensive array of applications, services, and systems, undertaking activities that include data processing, running software, and accessing content. The challenge is the necessity for a system that is both dynamic and responsive, capable of addressing user requirements while efficiently allocating resources. Presently, there is a lack of solutions capable of tailoring the same service or feature to the specific needs of individual customer sessions, especially during periods of system downtime.

The proliferation of online services and platforms has led to unprecedented demand for computational resources. This scenario presents a significant challenge in managing these resources efficiently to ensure optimal service delivery without unnecessary waste or environmental impact. Traditional resource allocation methods often struggle to adapt to dynamic user demands and fluctuating workloads, leading to inefficiencies that can affect both performance and user experience.

One major issue is the carbon footprint associated with digital operations. As data centers consume vast amounts of energy, there's a growing concern over the environmental impact of providing digital services. The challenge lies in optimizing resource use to minimize energy consumption and, by extension, reduce carbon emissions, without compromising service quality.

Another problem is the static nature of many resource allocation systems. These systems may not be capable of adapting in real time to changes in user demand, leading to either resource scarcity during peak times or excess capacity sitting idle, both of which are inefficient and costly.

The complexity of predicting user demand further complicates resource allocation. Without accurate predictions, it's difficult to allocate resources effectively, leading to potential bottlenecks and degraded service quality when systems are unexpectedly overloaded or underutilized resources during periods of low demand.

Additionally, the lack of integration between different components of the digital service delivery chain can hinder efficient resource allocation. Siloed operations and the absence of a holistic view of service demand across platforms can prevent effective coordination and optimization of resources.

The growing diversity of user requests and the need for personalized service delivery also present challenges. Systems must not only manage resources efficiently but also tailor their allocation to meet the specific needs of individual users or user groups, further complicating the allocation process.

Environmental sustainability has become a key concern for many organizations, adding another layer of complexity to resource allocation. There is a need to balance operational efficiency and environmental impact, requiring innovative approaches to reduce carbon emissions while maintaining high service levels.

Current solutions often involve manual intervention or complex, rule-based systems that cannot easily adapt to changing conditions or incorporate new data in real time, leading to suboptimal performance and increased operational costs.

The reliance on conventional computing resources for these tasks also limits the scalability and speed of resource allocation decisions, making it difficult to respond swiftly to immediate changes in demand or to optimize for environmental impact in real time.

Finally, the increasing public and regulatory pressure for sustainable practices in all areas of operation, including digital services, demands a new approach to resource allocation that prioritizes efficiency, adaptability, and environmental responsibility.

Hence there is a long felt and unsatisfied need to provide efficient and environmentally sustainable allocation of digital resources in response to dynamic and fluctuating user demands. Traditional systems have struggled to adapt in real-time to changing demands and to optimize resource usage without compromising service quality or increasing carbon footprints. The inventions disclosed herein offer solutions that dynamically adjust resource allocation, reduce energy consumption, and minimize environmental impact, all while maintaining high levels of service quality and user satisfaction.

### SUMMARY OF THE INVENTION

A novel approach to digital resource allocation, leveraging the power of Photonic Quantum Computing and artificial intelligence (AI), is disclosed. The method initiates by proactively identifying and grouping user requests with similar intents across various channels, organizing them into segments based on specific timeframes to streamline the processing of data. This organization ensures that requests, despite their diverse origins, are refined and converted into standardized, actionable commands. At the core of this system, Photonic Quantum simulation matches user requests with the most carbon-efficient resources for execution. Utilizing a Photonic Quantum-based resource generator, the system creates multiple schemas tailored to the execution of user requests, following an in-depth feature extraction process. These schemas, derived from a comprehensive resource pooling network, undergo evaluation by the Photonic Quantum simulator to assess their carbon efficiency. The simulator calculates a carbon score for each schema, selecting the optimal one for executing user actions within designated time intervals. Finally, a destruction unit reclaims the resources used in the schema, returning them to the resource pool, ensuring efficient resource management and sustainability.

The invention(s) disclosed herein aim to manage digital resources dynamically and efficiently in real-time, responding to fluctuating user demands while minimizing environmental impacts, particularly carbon emissions. This system is designed to understand user intents through AI, consolidating similar requests to optimize the allocation process. Photonic Quantum Computing enables rapid simulation and evaluation of different allocation strategies, ensuring the most efficient and sustainable pathway is chosen for each request.

The invention(s) utilize predictive analytics to anticipate user needs and adjust resource distribution, accordingly, ensuring high availability and responsiveness. This anticipatory approach allows for more effective use of computing resources, reducing idle times and excess capacity, which in turn decreases energy consumption and carbon footprint. The system's AI component provides for processing and analyzing vast amounts of data to understand and predict user behavior patterns.

The invention(s) employ a novel method of grouping user requests based on intent, which allows for more nuanced and targeted resource allocation. This grouping mechanism not only improves efficiency but also enhances the user experience by providing more personalized responses to user interactions.

The Photonic Quantum Computing aspect of the invention(s) offers unprecedented speed and efficiency in evaluating potential resource allocation strategies. By leveraging Quantum Computing, the system can quickly simulate numerous scenarios to find the most carbon-efficient allocation, a task that would be prohibitively slow or impossible with traditional computing resources.

The environmental sustainability of digital services is a benefit of the invention(s). By optimizing resource allocation to reduce unnecessary energy use, it contributes to a reduction in the overall carbon footprint of digital operations. This aspect is increasingly important as digital services expand and environmental concerns grow.

The system's dynamic allocation capabilities allow it to adapt to real-time changes in demand, ensuring that resources are allocated where they are most needed without over-provisioning. This adaptability is for handling peak demand periods and unexpected surges in user activity.

Integration and coordination across different service components are enhanced by the invention's holistic approach to resource management. This ensures that all parts of the service delivery ecosystem work together efficiently, eliminating bottlenecks and improving overall service quality.

The use of AI and Quantum Computing also introduces the possibility of continuous learning and improvement. The system can evolve its allocation strategies based on past performance and emerging user trends, ensuring that it remains effective over time.

Real-world applications of this technology span across various digital platforms and services, promising to revolutionize how resources are managed in data centers, cloud computing environments, and online service platforms. This can provide significant cost savings, improved user satisfaction, and a notable reduction in the environmental impact of digital services.

Thus, the invention(s) disclosed herein address the need for sustainable, efficient, and adaptive resource allocation in the digital realm. By combining AI with Photonic Quantum Computing, they offer a solution that is both technologically advanced and environmentally responsible, setting a new standard for the future of digital service provision.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a method is provided for dynamically allocating digital resources within a computing environment. This involves using an artificial intelligence (AI) model to predict user demands by processing incoming requests and identifying intents and patterns. Natural language processing (NLP) techniques are applied to pre-process these requests to filter noise and extract key phrases and intents. The method further includes employing machine learning models that have been trained on historical data to improve the accuracy of these predictions. These models are updated with new data as it comes in. Additionally, user requests are categorized into distinct groups for targeted resource allocation.

The method leverages Photonic Quantum Computing, which uses Quantum algorithms designed for optimization problems to simulate various resource allocation strategies. These simulations are adjusted in real-time based on feedback. The most carbon-efficient strategy is selected using a multi-criteria decision-making process that can consider the quality of user experience. If the performance is suboptimal, fallback strategies can be implemented.

The method can utilize feedback loops to collect performance data, including user satisfaction metrics and environmental impact measurements. This data can then be used to refine the AI model and simulation algorithms. The resource allocation is dynamically adjusted in response to real-time changes in demand and system capacity. Environmental impact data is integrated to improve the carbon efficiency scoring algorithm. Lastly, the method allows for user-configurable settings to prioritize different aspects of service delivery according to preferences or policies.

In some arrangements, the method includes the use of distributed ledger technology to log and verify all changes in resource allocation and environmental impact metrics. This technology ensures transparency and accountability throughout the resource allocation process.

In some arrangements, the distributed ledger technology is employed to enable real-time auditability of resource allocation decisions and their environmental impacts by stakeholders. This capability enhances trust in the sustainability practices of the system.

In some arrangements, the method utilizes a continuous optimization loop that employs genetic algorithms. These algorithms evolve the resource allocation strategies based on performance feedback, ensuring ongoing improvements in efficiency and sustainability.

In some arrangements, there is a user interface provided that offers insights into the carbon efficiency and environmental impact of the user's activities. This feature is designed to promote awareness and encourage sustainable usage patterns.

In some arrangements, the method executes predictive maintenance algorithms. These algorithms are used to preemptively identify and address potential inefficiencies in the computing environment, with the aim of reducing downtime and conserving resources.

In some arrangements, a method includes predicting user demands using an AI model to process incoming user requests, identifying intents and patterns. This method also aggregates similar requests into consolidated profiles for more efficient resource allocation. Photonic Quantum Computing is then employed to simulate various strategies, which are assessed for their carbon efficiency and demand fulfillment capability.

In some arrangements, the method further involves pre-processing incoming user requests to filter out irrelevant data. This pre-processing can include using NLP techniques to extract key phrases and intents, enhancing the prediction accuracy.

In some arrangements, machine learning models, trained on historical data, are used to improve the accuracy of intent prediction and demand aggregation. These models are continually updated with new user interaction data to refine the predictions.

In some arrangements, user requests are categorized based on predicted intents, which allows for targeted resource allocation. This categorization ensures that resources are directed to where they are most needed.

In some arrangements, Photonic Quantum Computing includes the use of Quantum algorithms specifically tailored for optimization problems. These algorithms contribute to the efficient simulation of resource allocation strategies.

In some arrangements, the method includes adjusting Quantum simulation parameters based on real-time feedback. This ensures that the resource allocation strategies are continuously optimized for the current state of the computing environment.

In some arrangements, a multi-criteria decision-making process is employed to select the resource allocation strategy. This process weighs carbon efficiency against user experience quality to determine the most suitable strategy.

In some arrangements, fallback strategies are implemented if the primary resource allocation strategy does not meet performance expectations. These strategies act as a safety net to maintain service quality.

In some arrangements, the method includes feedback loops that collect user input on service quality. This direct feedback from users is used to influence future resource allocation decisions, ensuring the system evolves according to user needs.

In some arrangements, a system is established to dynamically allocate digital resources within a computing environment. This system incorporates an AI module designed to process and predict user demands by identifying their intents and patterns through incoming requests. A natural language processing unit is included to pre-process these requests, extracting key phrases and intents for better accuracy in demand prediction.

In some arrangements, the system also features a machine learning engine. This engine uses historical data to refine the prediction of user demands and is capable of incorporating new interaction data dynamically for ongoing learning and improvement.

In some arrangements, the system is equipped with a Quantum Computing module. This module houses Photonic Quantum processors that simulate and evaluate various resource allocation strategies, focusing on carbon efficiency as a key metric.

In some arrangements, there is a decision-making framework within the system. This framework selects the optimal resource allocation strategy by considering both carbon efficiency and user experience. It works in tandem with a real-time monitoring system that adjusts resource allocation in response to changes in demand and system performance.

In some arrangements, the system includes a feedback collection mechanism. This mechanism gathers performance data, including user satisfaction and environmental impact, to inform strategy adjustments and improvements.

In some arrangements, the system integrates an environmental impact assessment tool. This tool refines the carbon efficiency scoring of strategies to help in the selection of the most environmentally sustainable options.

In some arrangements, the system offers a user interface. This interface allows users to configure service delivery priorities, and it integrates with external databases for environmental impact metrics. It also uses distributed ledger technology for the transparent logging of resource allocation decisions.

In some arrangements, the system further incorporates an energy management module. This module is tasked with optimizing the power consumption of the computing environment. It dynamically adjusts energy usage based on the current demand and the selected resource allocation strategy, aiming to further reduce the environmental impact of the operations.

In some arrangements, there is also a user analytics module within the system. This module uses the data processing capabilities of the AI module to provide personalized insights and recommendations, encouraging users to adopt more sustainable digital practices and thus promoting environmental awareness.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a first portion of a conceptual, functional, flow diagram showing sample interactions, interfaces, steps, functions, and components in accordance with one or more “initiation and request consolidation” aspects of this disclosure as they relate to resource allocation systems for carbon efficiency.

FIG. 2 depicts a second portion of a conceptual, functional, flow diagram showing sample interactions, interfaces, steps, functions, and components in accordance with one or more “planning and execution” aspects of this disclosure as they relate to resource allocation systems for carbon efficiency.

FIG. 3 depicts a third portion of a conceptual, functional, flow diagram showing sample interactions, interfaces, steps, functions, and components in accordance with one or more “carbon-efficient resource pool” aspects of this disclosure as they relate to resource allocation systems for carbon efficiency.

FIG. 4 depicts a fourth portion of a conceptual, functional, flow diagram showing sample interactions, interfaces, steps, functions, and components in accordance with one or more “closure and resource-pooling” aspects of this disclosure as they relate to resource allocation systems for carbon efficiency.

FIG. 5 depicts a conceptual, functional, flow diagram showing sample interactions, interfaces, steps, functions, and components in accordance with one or more “Quantum-based action simulator” aspects of this disclosure as they relate to utilization of Quantum simulation to simulate various scenarios and match them to user intentions accurately and thereby select a winning schema.

FIG. 6A depicts a combination, architectural and functional flow diagram showing sample interactions, interfaces, steps, functions, and components as they relate to for resource allocation systems for carbon efficiency.

FIG. 6B depicts a combination, architectural and functional flow diagram showing sample interactions, interfaces, steps, functions, and components as they relate to resource allocation systems for carbon efficiency.

FIG. 7 depicts a sample flow diagram showing sample interactions, interfaces, steps, functions, and components as they relate to potential process steps for resource allocation systems for carbon efficiency.

FIG. 8 depicts a sample flow diagram showing sample interactions, interfaces, steps, functions, and components as they relate to potential process steps for resource allocation systems for carbon efficiency.

FIG. 9 depicts a sample system flow showing sample interactions, interfaces, steps, functions, and components as they relate to resource allocation systems for carbon efficiency.

### DETAILED DESCRIPTION

The subsequent description of different embodiments aims to achieve the aforementioned goals, with reference to accompanying drawings that are integral to this document. These drawings illustrate several ways in which the disclosed information can be implemented. It should be recognized that alternative embodiments are possible, and modifications to structure and function can be made. This description mentions various connections between elements, which should be understood as broad and, unless otherwise indicated, can be direct or indirect, wired, or wireless. This specification is not meant to restrict these connections.

Throughout this document, the term “computers,” “machines,” or similar references are used interchangeably, depending on the context, to denote devices that may be general-purpose, customized, configured for specific purposes, virtual, physical, or capable of accessing networks. These include all associated hardware, software, and components as would be recognized by someone skilled in the field. Such devices might be equipped with one or more application-specific integrated circuits (ASICs), microprocessors, cores, or executors for running, accessing, controlling, or implementing various software, instructions, data, modules, processes, or routines as described herein. The references in this text are not to be seen as restrictive or exclusive to any particular type(s) of electronic device(s) or component(s) and should be understood in the broadest sense as per the knowledge of skilled individuals. Details on specific or general computer/software components, machines, etc., are omitted for conciseness and because they are assumed to be within the understanding of competent professionals in the field.

Software, computer-executable instructions, data, modules, processes, and similar elements can reside on physical storage media that is tangible and computer readable. This includes local memory, network-attached storage, and various forms of accessible memory whether removable, remote, cloud-based, or available through other means. Such elements can be stored in either volatile or non-volatile memory types and can operate in various modes such as autonomously, on-demand, on a schedule, spontaneously, proactively, or reactively. They may be stored collectively or dispersed across different computers or devices, encompassing their memory and additional components. Furthermore, these elements can also be stored or distributed across network-accessible storages, within distributed databases, big data environments, blockchains, or distributed ledger technologies, either in a similar fashion or via distributed means.

In this disclosure, the term “networks” or the like encompasses a variety of communication infrastructures, including local area networks (LANs), wide area networks (WANs), the Internet, cloud networks, both wired and wireless networks, digital subscriber line (DSL) networks, frame relay networks, asynchronous transfer mode (ATM) networks, and virtual private networks (VPN). These can be interconnected directly or indirectly. Networks may feature distinct interfaces tailored for internal, external, and management communications, with the option to assign virtual IP addresses (VIPs) to each as needed. The infrastructure of a network comprises various hardware and software components, including but not limited to access points, adapters, buses, ethernet adapters (both physical and wireless), firewalls, hubs, modems, routers, and switches. These components can be located within the network, at its edges, or externally. Additionally, software and computer-executable instructions operate on these components, facilitating network functions. Networks are capable of supporting HTTPS and various other communication protocols suitable for packet-based transmission and communication.

As used herein, Generative Artificial Intelligence (AI) or the like refers to AI techniques that learn from a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used in accordance with various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models-Meta LLaMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in the field of biology and medicine. (5) NVIDIA AI Models-Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in the field of generative AI. One or more of the foregoing may be used herein as desired. All are considered to be within the sphere and scope of this disclosure.

Generative AI and LLMs can be used in various aspects of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and utilizing large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

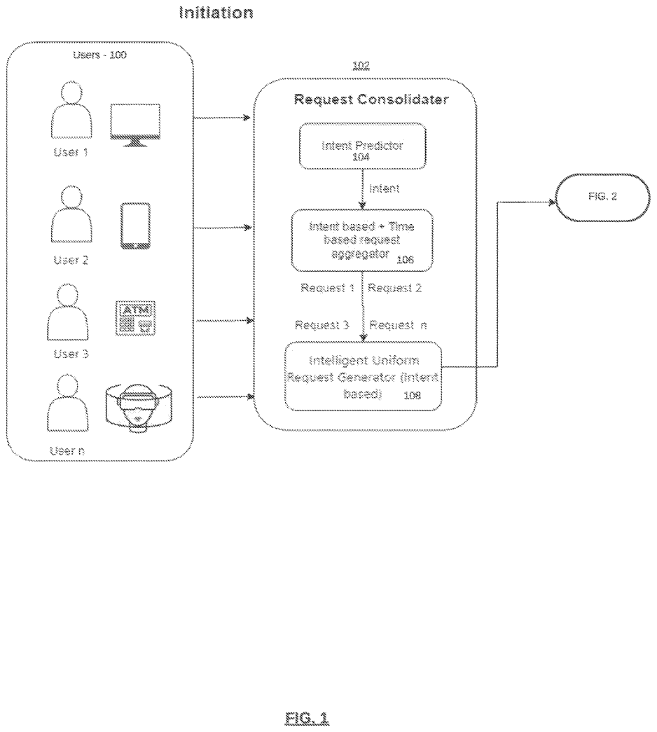

FIGS. 1-4 outline a multi-part conceptual framework for an intelligent resource allocation system, focusing on carbon efficiency through the use of Photonic Quantum Computing.

FIG. 1 shows the initiation and request consolidation aspects, demonstrating how user requests are processed and consolidated based on intent, using AI and Quantum Computing to predict and aggregate demands.

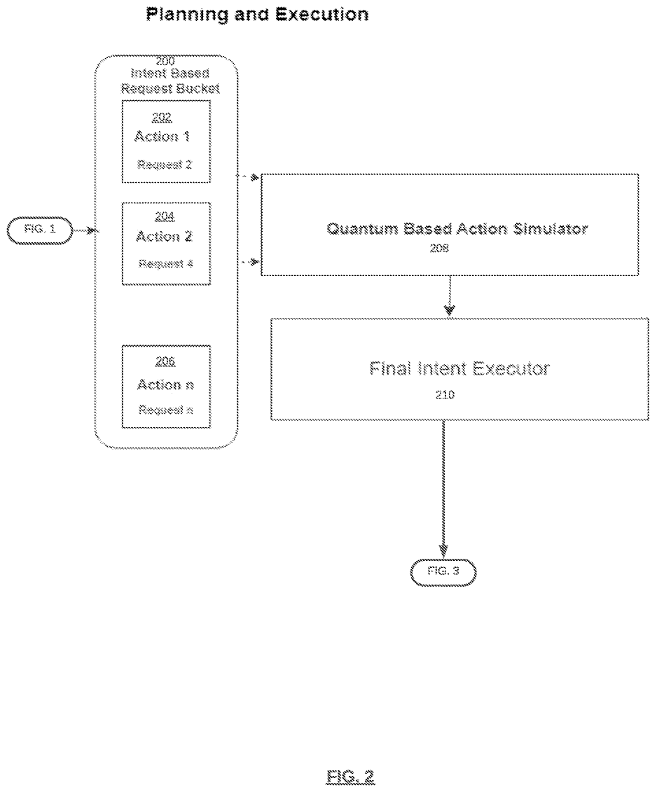

FIG. 2 details the planning and execution phases, where intent-based request buckets are created, and a Quantum-based action simulator evaluates the best course of action and schema, leading to the execution of tasks by a final intent executor.

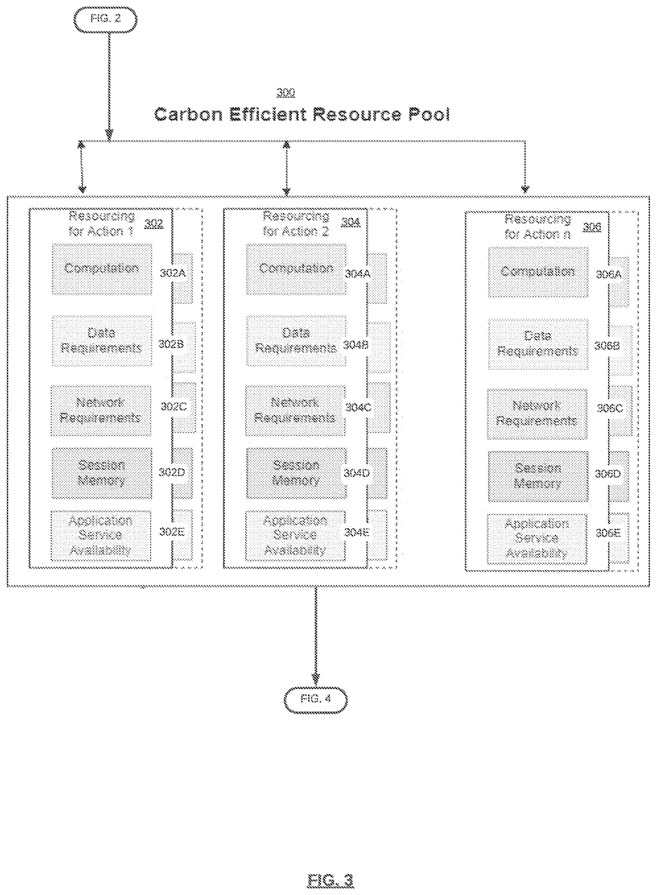

FIG. 3 illustrates the resource pooling aspect, focusing on allocating resources in a carbon-efficient manner across computational, data, network, and service availability parameters for various actions.

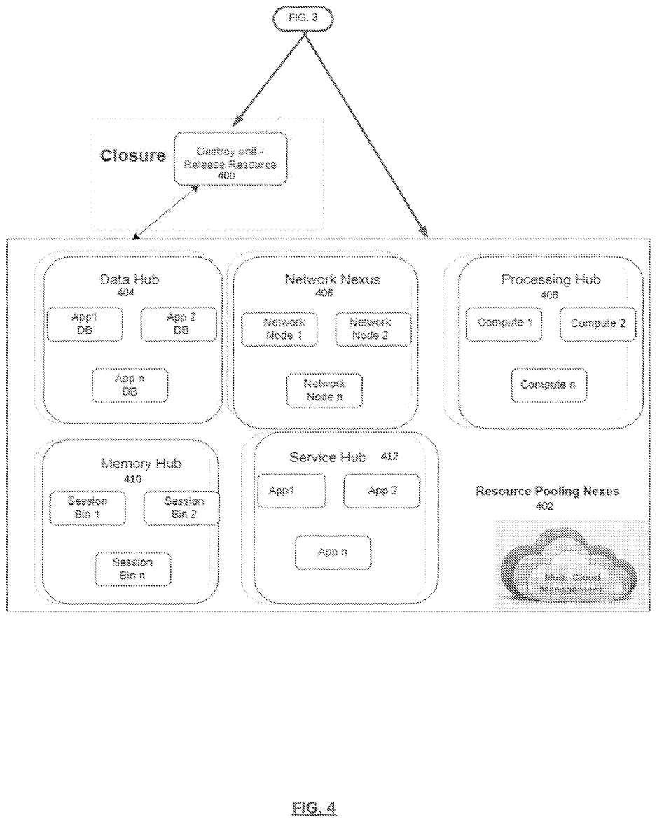

FIG. 4 depicts the closure and resource-pooling aspects, including the release of resources and the deconstruction of used elements, ensuring efficient use and reallocation in a closed-loop system to minimize waste and carbon output.

Together, these figures provide a detailed view of a system designed to optimize digital interactions for efficiency and environmental sustainability. In the initial stages, every user request received through various communication channels is systematically categorized based on its inherent intent. An advanced intent prediction mechanism scrutinizes these requests to determine the users' underlying objectives, ensuring that every action, regardless of its origin (mobile, desktop, or any other platform), is understood uniformly.

This intent prediction process aligns the system's response mechanisms with the specific needs of the users. Following this, the system aggregates requests within a defined timeframe, allowing for the efficient processing of similar intents collectively. This step provides for actions common across platforms ensuring consistency in handling irrespective of the request's source.

Subsequently, these requests are synthesized into a uniform pattern through a request generator. This harmonization addresses the challenge of varying request formats emanating from different channels —for example, differences between requests from ATMs and online banking platforms. Despite these differences, the uniform request generator identifies and consolidates these requests based on their shared intent, streamlining the process.

The Intent-Based Action Bucket organizes actions tied to specific intents. This organization ensures that requests are not only grouped by their stated purpose but are also prepared for processing in a manner that aligns with their intended outcomes. Actions are then subjected to a Quantum-based simulation, which meticulously evaluate and score potential resource allocation schemas. This evaluation focuses on identifying a schema that not only addresses the requests effectively but also prioritizes carbon efficiency, reflecting a commitment to environmental sustainability.

The Quantum simulator offers a dual advantage: it accelerates the process of schema selection and ensures that the chosen schema minimizes carbon emissions. This dual functionality exemplifies the system's innovative use of Quantum Computing to enhance operational efficiency and sustainability. The simulator assesses each schema against carbon efficiency criteria so that the system's environmental footprint is kept to a minimum.

As the system processes and evaluates these schemas, it dynamically allocates resources—computational power, data, network capabilities, and memory—based on the specific demands of each action. This dynamic allocation is informed by the complexity of the request and the volume of similar requests, ensuring that resources are used judiciously and efficiently. Security protocols and data standardization measures further ensure that the system's operations are secure and consistent across different services.

This comprehensive approach to handling user requests illustrates a sophisticated orchestration of technology and sustainability. By leveraging the capabilities of Quantum Computing, the system not only responds adeptly to user interactions but also champions a low-carbon operational model. This model underscores the system's ability to adapt in real-time to varying user needs while steadfastly committing to reducing its environmental impact.

By way of non-limiting disclosure, FIG. 1 depicts a first portion of a conceptual, functional, flow diagram showing sample interactions, interfaces, steps, functions, and components in accordance with one or more initiation and request consolidation aspects of this disclosure as they relate to resource allocation systems for carbon efficiency.

In general FIG. 1 of the illustrates the initial phase of a resource allocation system, showcasing the mechanisms by which user requests are processed for carbon-efficient operations. This phase encompasses the receipt and analysis of user inputs from users 100, where an AI model predicts user demands by interpreting the underlying intents and patterns of incoming requests. The process of pre-processing these requests using NLP techniques helps to refine the data by filtering out extraneous noise and extracting the key phrases and intents for understanding user needs.

Similar requests are aggregated based on their identified intents, forming what are known as consolidated demand profiles. This step enables efficient resource allocation as it allows the system to handle multiple requests that share the same intent in a grouped manner rather than individually.

FIG. 1 sets the stage for employing Photonic Quantum Computing to simulate various resource allocation strategies for these consolidated demand profiles. This simulation would involve evaluating each strategy's potential carbon efficiency and its capacity to meet the predicted demand.

This initiation portion can also include feedback and adjustment mechanisms that refine the resource allocation strategies, ensuring that the system dynamically adapts to real-time user activity and system performance data.

Overall, FIG. 1 serves as a foundational blueprint for the initiation and request consolidation steps that prime the resource allocation system for the planning and execution stages, which are further elaborated in subsequent figures.

In FIG. 1, the Request Consolidator (102) is a central component of the system, encompassing several key functions. It includes the Intent Predictor (104), which analyzes incoming user requests to determine the underlying intents and patterns. This prediction influences how the system will respond to the request by identifying what the user is trying to achieve.

Once user intentions are predicted, they are transformed into what is termed as ‘derived intents’. These are more refined interpretations of the user's initial requests, taking into account the nuances and context that may not be explicitly stated. This derivation helps in understanding the true purpose behind a request, allowing for more accurate service and resource allocation.

Following the prediction and derivation of intents, the Intent-Based+Time-Based Request Aggregator (106) comes into play. This component takes the derived intents and aggregates them with other similar requests. It considers both the nature of the requests and the timing, combining those that are alike or related and those that occur within a similar timeframe. This aggregation is designed to optimize the processing of requests by grouping together those that can be addressed through similar resources or actions.

The output of this aggregation process is then channeled to an Intelligent Uniform Request Generator (Intent-Based). This generator takes the consolidated requests and reformulates them into a standardized format that can be understood and processed by the downstream systems. This standardization is key to ensuring that the various components of the resource allocation system can interact seamlessly, with a clear and uniform understanding of each request.

Overall, the Request Consolidator (102) acts as the system's initial processing hub, preparing user requests for the subsequent stages of resource allocation, ensuring efficiency, and aiming to fulfill the intents in a carbon-efficient manner.

By way of non-limiting disclosure, FIG. 2 depicts a second portion of a conceptual, functional, flow diagram showing sample interactions, interfaces, steps, functions, and components in accordance with one or more planning and execution aspects of this disclosure as they relate to resource allocation systems for carbon efficiency.

In FIG. 2, the output from the Intelligent Uniform Request Generator (108) from FIG. 1, which is standardized and intent-based, is fed into the Intent Based Request Bucket (200). This bucket is designed to sort and group actions and requests (202, 204, 206) according to their identified intents. This grouping allows for a more organized and focused approach to handling requests, ensuring that similar demands are processed in a coordinated manner.

From the Intent Based Request Bucket (200), the gathered requests and associated actions are then provided to the Quantum Based Action Simulator (208). This simulator uses advanced Quantum algorithms to predict the outcomes of various potential actions and determine the most carbon-efficient and effective strategies. This predictive capability is key for ensuring that the resources are allocated not only efficiently but also with an eye towards minimizing the carbon footprint of the computing environment.

The output of the Quantum Based Action Simulator (208) is a selection of optimal actions and resource allocations, which is then passed on to the Final Intent Executor (210). The Final Intent Executor is responsible for carrying out the chosen actions, ensuring that the user's intent is fulfilled efficiently and effectively. This component translates the Quantum simulation's decisions into real-world actions within the computing environment, completing the process initiated by the user's request.

Overall, FIG. 2 illustrates a detailed and methodical process from the standardization of user requests to the execution of intent-based actions, all optimized for carbon efficiency through the integration of Quantum Computing technologies.

By way of non-limiting disclosure, FIG. 3 depicts a third portion of a conceptual, functional, flow diagram showing sample interactions, interfaces, steps, functions, and components in accordance with one or more carbon-efficient resource pool aspects of this disclosure as they relate to resource allocation systems for carbon efficiency.

In FIG. 3, the Carbon Efficient Resource Pool (300) is highlighted as a pivotal element in the system, designed to manage and allocate resources across various actions in a manner that prioritizes carbon efficiency. The output from the Final Intent Executor (210) from FIG. 2 is directed towards this resource pool, marking the transition from decision-making to the actual allocation and utilization of resources.

The Carbon Efficient Resource Pool is segmented into resources dedicated to specific actions, labeled as Resources for Action 1 (302), Resources for Action 2 (304), and extending to Resources for Action “N” (306), indicating a scalable and flexible system capable of handling a multitude of different actions simultaneously. Each action-specific resource segment includes several sub-components for the execution of actions:
a. Computation (302A/304A/306A): These components are responsible for providing the necessary computational power required to execute each action. They ensure that the actions are supported by adequate processing capabilities, scaled according to the demands of each specific intent.
b. Data Requirements (302B/304B/306B): This aspect covers the data storage, access, and processing needs associated with each action. It ensures that all data-related prerequisites are met, from the availability of necessary information to the provision of data storage solutions.
c. Network Requirement (302C/304C/306C): Networking components facilitate communication and data exchange for executing actions. This includes ensuring connectivity, bandwidth, and security measures are in place and optimized for efficiency.
d. Session Memory (302D/304D/306D): Session-specific memory allocations are provided for each action, ensuring that temporary storage is available for the duration of the action execution. This supports the temporary holding of data, states, and intermediate computations.
e. Application Service Availability (302E/304E/306E): Ensuring that the necessary application services are available and operational for each action. This involves coordinating with various service providers and internal resources to ensure that the required services are ready and accessible.

The structured organization within the Carbon Efficient Resource Pool allows for a highly efficient and effective allocation of resources, tailored to the specific requirements of each action while prioritizing carbon efficiency. This detailed arrangement facilitates a systematic approach to resource management, ensuring that all aspects of action execution are supported optimally, from computation and data handling to networking and service availability.

By way of non-limiting disclosure, FIG. 4 depicts a fourth portion of a conceptual, functional, flow diagram showing sample interactions, interfaces, steps, functions, and components in accordance with one or more closure and resource-pooling aspects of this disclosure as they relate to resource allocation systems for carbon efficiency.

In FIG. 4, the system transitions from the strategic allocation of resources, as seen in the Carbon Efficient Resource Pool of FIG. 3, into the operational and management phase through the Closure Module and Resource Pooling Nexus. This transition begins with the output from the Carbon Efficient Resource Pool being inputted into the Closure Module, where a “Destroy Unit—Release Resource Process” (400) is executed. This process ensures that resources are efficiently recycled or released back into the pool after their use is concluded, minimizing waste, and optimizing the system's overall carbon efficiency.

Subsequently, the Resource Pooling Nexus (402) manages and redistributes these resources across the system. It comprises several components:
a. Data Hub (404): This hub acts as a central repository for application databases, storing and managing data across various applications. It ensures that data is efficiently organized and accessible for future actions, contributing to the system's overall efficiency and responsiveness.
b. Network Nexus (406): Including network nodes, this component is responsible for managing the system's networking infrastructure. It ensures that communication between different parts of the system is seamless and efficient, supporting the rapid transmission of data and requests.
c. Processing Hub (408): Containing computation modules, the Processing Hub is for providing the computational power needed to execute various actions and processes within the system. It dynamically allocates processing resources to meet the demands of different tasks, ensuring optimal performance.
d. Memory Hub (410): This hub includes session bins for temporary storage needs. It is designed to manage the session-specific memory requirements of actions, providing temporary holding spaces for data during processing and execution phases.
e. Service Hub (412): Incorporating applications, the Service Hub manages the availability and allocation of application services across the system. It ensures that all necessary services are readily available for executing actions, contributing to the system's functionality and user satisfaction.

The design of the Resource Pooling Nexus allows for the efficient management and reallocation of resources across the system, ensuring that every component operates at peak efficiency with minimal environmental impact. This structure not only supports the system's operational needs but also aligns with the overarching goal of carbon efficiency by optimizing resource use and minimizing waste.

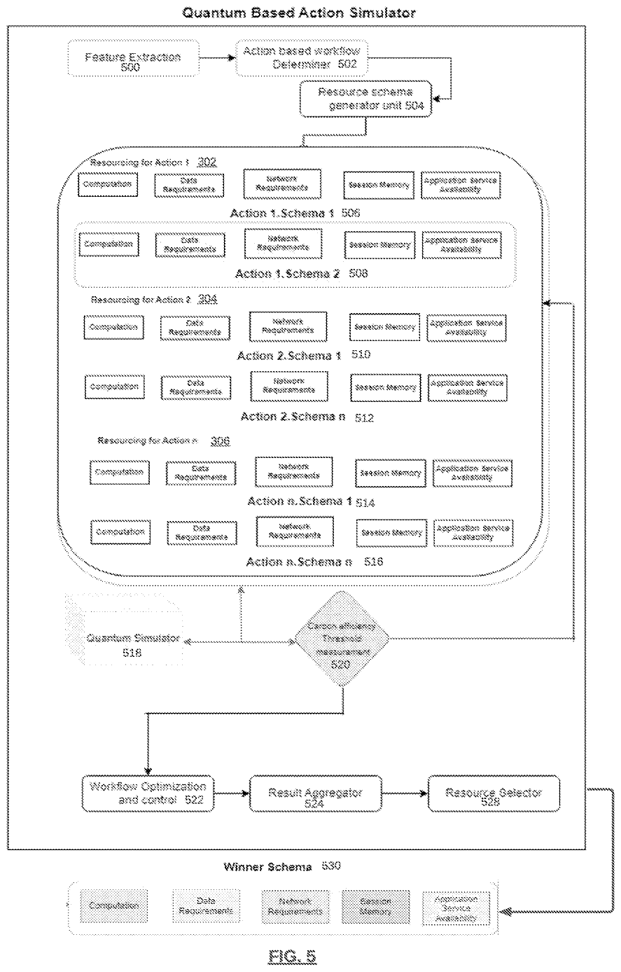

By way of non-limiting disclosure, FIG. 5 depicts a conceptual, functional, flow diagram showing sample interactions, interfaces, steps, functions, and components in accordance with one or more Quantum-based action simulator aspects of this disclosure as they relate to resource allocation systems for carbon efficiency.

In FIG. 5, the process begins with Feature Extraction (500), where essential characteristics and information are drawn from the incoming data. This step ensures that the subsequent modules process only relevant and meaningful data, thereby enhancing the efficiency of the system.

The extracted features are then fed into the Action Based Workflow Determiner (502), which analyzes the data to determine the most appropriate workflow based on the actions required. This determination aligns the process flow with the specific needs and intents of the requests, ensuring that each action is addressed in the most effective manner.

Following this, the Resource Schema Generator Unit (504) takes over. It utilizes the insights from the Action Based Workflow Determiner to create various resource allocation schemas. These schemas are tailored to meet the requirements of the determined actions, proposing different ways resources can be allocated to achieve the desired outcomes.

The Resourcing for Actions and the corresponding actions and schemas are then evaluated by a Quantum Simulator (518). This evaluation is pivotal, as the Quantum Simulator applies Quantum Computing algorithms to predict the outcomes of the different schemas, assessing them for efficiency and effectiveness. It simulates the execution of each schema to identify the one that optimizes resource use and meets the action requirements most effectively.

Parallel to the simulation, a Carbon Efficiency Threshold Measurement (520) is performed. This step assesses each schema against predefined carbon efficiency criteria, ensuring that the selected resource allocation strategy not only meets functional requirements but also aligns with environmental sustainability goals.

The outputs from the Quantum Simulator and the Carbon Efficiency Threshold Measurement are then processed by the Workflow Optimization and Control (422). This component optimizes the workflow by integrating the insights gained from the simulation and measurement, fine-tuning the process for better efficiency and carbon footprint reduction.

The optimized workflow data is aggregated by the Result Aggregator (524), which compiles and synthesizes the information, preparing it for the final selection stage. This aggregation is key to ensuring that all relevant data is considered in deciding the optimal resource allocation schema.

Finally, the Resource Selector (528) chooses the Winner Schema (530), the resource allocation strategy that offers the best balance between action requirements and carbon efficiency. This selection marks the culmination of the process, identifying the schema that will be implemented to fulfill the action while minimizing environmental impact.

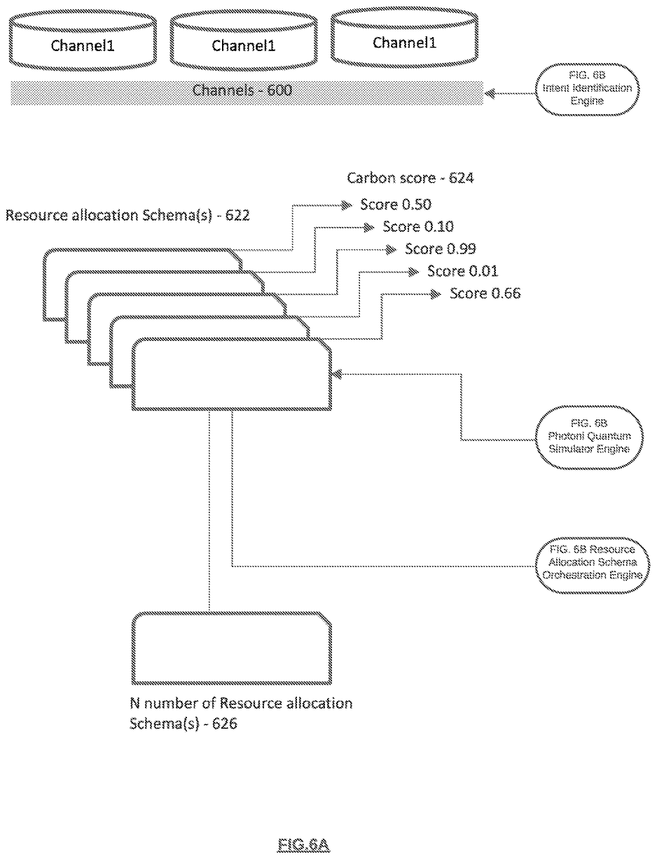

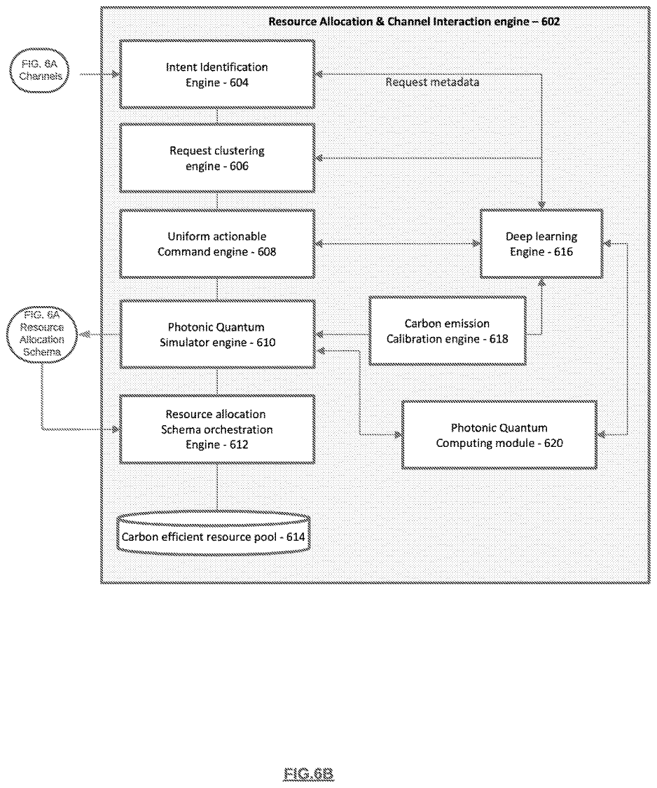

By way of non-limiting disclosure, FIGS. 6A and 6B in the document detail the architecture and functional flow of the resource allocation and channel interaction engine within the system for carbon efficiency. These figures elaborate on the comprehensive mechanism through which user requests are processed, resource allocation schemas are generated and evaluated, and the final execution of tasks is managed in a carbon-efficient manner.
a. Channels (600): Represents the various pathways through which user requests are received and processed. This includes different user interfaces, applications, or communication methods.
b. Resource Allocation & Channel Interaction Engine (602): Serves as the component that orchestrates the entire process, from identifying user intents to executing resource allocation strategies.
c. Intent Identification Engine (604): Focuses on analyzing incoming requests to determine their underlying intents. This component is for understanding what users are trying to achieve and how best to fulfill those needs.
d. Request Clustering Engine (606): Aggregates similar requests to streamline processing and resource allocation. This clustering is based on common characteristics or intents, allowing for more efficient handling of user needs.
e. Uniform Actionable Command Engine (608): Translates clustered requests into standardized commands that can be actioned upon. This ensures that the execution phase is based on a uniform understanding of user requests.
f. Photonic Quantum Simulator Engine (610): Utilizes Quantum Computing to simulate and evaluate different resource allocation strategies, ensuring the most efficient and carbon-effective approach is chosen.
g. Schema Orchestration Engine (612): Manages the selection and implementation of the optimal resource allocation schema based on the outcomes of the Quantum simulation.
h. Photonic Quantum Computing Module (620): Provides the computational power for the Quantum simulator engine, enabling complex simulations at unprecedented speeds.
i. Carbon Efficient Resource Pool (614): A repository of resources managed in a way that prioritizes carbon efficiency, ensuring that the execution of tasks is as environmentally friendly as possible.

FIG. 6B continues the narrative from FIG. 6A, focusing on the downstream aspects of the resource allocation process. This can include the implementation of the selected resource allocation schema, monitoring and adjusting the execution based on real-time feedback, and the evaluation of carbon efficiency post-execution.

FIG. 6B illustrates how the system ensures ongoing optimization and sustainability of resource allocation, incorporating feedback loops, performance metrics, and environmental impact assessments to continuously refine and enhance the system's carbon efficiency.

Together, FIGS. 6A and 6B provide a comprehensive view of the system's approach to handling user requests in a manner that is both efficient and environmentally responsible, leveraging advanced technologies such as Photonic Quantum Computing and AI-driven analysis to optimize resource allocation and reduce carbon emissions.
a. Intent Identification Engine—(604): This component analyzes request metadata to understand the underlying intent of user requests. By identifying what users are attempting to achieve, the system can tailor its resource allocation strategies to meet these needs effectively and efficiently.
b. Request Clustering Engine—(606): After intents are identified, similar requests are clustered together. This grouping allows the system to handle multiple requests in a consolidated manner, improving the efficiency of resource allocation and reducing unnecessary computational expenditure.
c. Uniform Actionable Command Engine—(608): This engine translates clustered requests into a uniform format that can be readily acted upon. By standardizing requests, the system ensures consistency in how actions are determined and executed across different scenarios.
d. Photonic Quantum Simulator Engine—(610): Utilizing the power of Photonic Quantum Computing, this engine simulates various resource allocation strategies to identify the most effective approach. The simulation accounts for both the fulfillment of user intents and the optimization of carbon efficiency.
e. Deep Learning Engine—(616) and Carbon Emission Calibration Engine—(618):

These components refine the system's understanding and response to requests using advanced machine learning techniques. They ensure that the system's decisions continuously improve in accuracy and efficiency, particularly in reducing carbon emissions.
f. Resource Allocation Schema Orchestration Engine—(612): This engine orchestrates the chosen resource allocation strategy, ensuring that resources are allocated according to the optimized plan derived from the Quantum simulations and deep learning insights.
g. Photonic Quantum Computing Module—(620): The backbone of the Quantum simulation, this module provides the computational power necessary to analyze and evaluate different allocation strategies at Quantum speed, facilitating real-time decision-making and optimization.
h. Carbon Efficient Resource Pool: The culmination of the process, where allocated resources are managed in a way that prioritizes carbon efficiency, ensuring that the system's operations contribute to environmental sustainability.

Together, FIGS. 6A and 6B provide a comprehensive overview of a system designed to intelligently and efficiently allocate resources in digital environments, leveraging cutting-edge technologies to minimize carbon footprints and optimize operational efficiency.

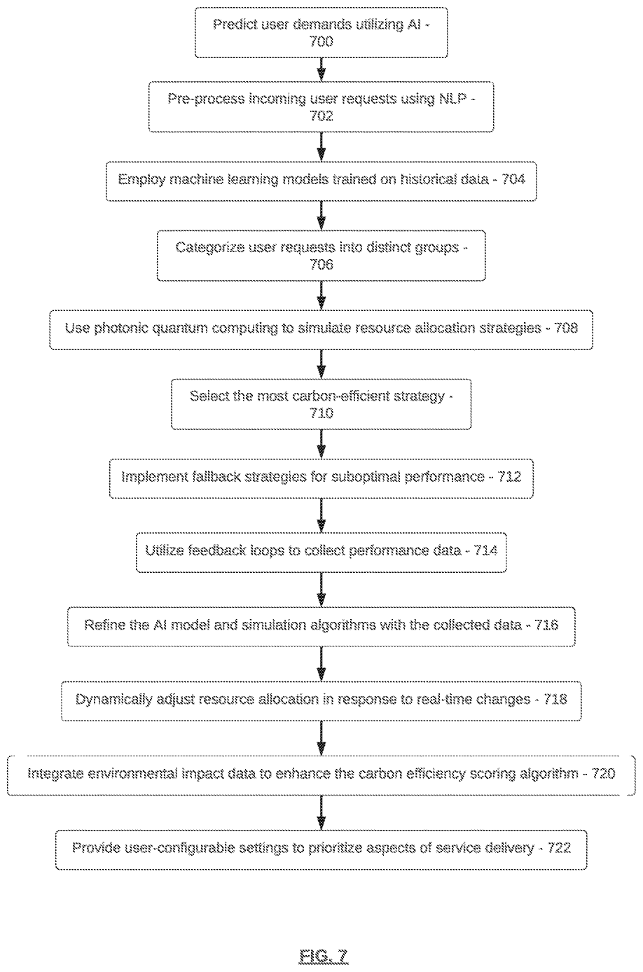

By way of non-limiting disclosure, FIG. 7 depicts a sample flow diagram showing sample interactions, interfaces, steps, functions, and components as they relate to resource allocation systems for carbon efficiency. FIG. 7 shows a method for dynamically allocating digital resources in a computing environment comprising one or more steps, such as:
a. predicting user demands utilizing an artificial intelligence (AI) model (700) that processes incoming user requests to identify underlying intents and patterns;
b. pre-processing incoming user requests using natural language processing (NLP) techniques (702) to filter out noise and extract key phrases and intents;
c. employing machine learning models trained on historical data (704) to improve the accuracy of intent prediction and demand aggregation, wherein the models are dynamically updated with new data;
d. categorizing user requests into distinct groups (706) for targeted resource allocation;
e. using Photonic Quantum Computing with Quantum algorithms (708) designed for optimization problems to simulate various resource allocation strategies, adjusting simulation parameters based on real-time feedback;
f. selecting the most carbon-efficient strategy (710) through a multi-criteria decision-making process that also considers user experience quality;
g. implementing fallback strategies for suboptimal performance (712);
h. utilizing feedback loops (714), including user satisfaction metrics and environmental impact measurements, to collect performance data;
i. refining the AI model and simulation algorithms with the collected data (716);
j. dynamically adjusting resource allocation in response to real-time changes in demand and system capacity (718);
k. integrating environmental impact data to enhance the carbon efficiency scoring algorithm (720); and
l. providing user-configurable settings (722) to prioritize aspects of service delivery according to preferences or policies.

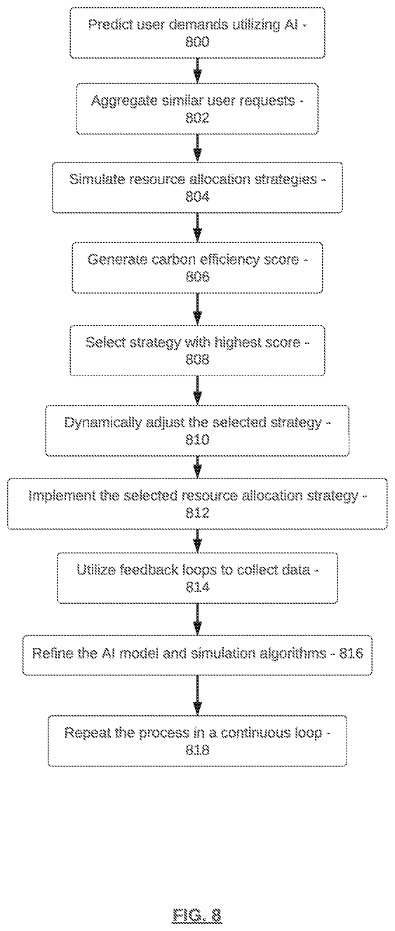

By way of non-limiting disclosure, FIG. 8 depicts a sample flow diagram showing sample interactions, interfaces, steps, functions, and components as they relate to resource allocation systems for carbon efficiency.

FIG. 8 shows a method for dynamically allocating digital resources in a computing environment comprising one or more steps, such as:
a. predicting user demands utilizing an artificial intelligence (AI) model that processes incoming user requests to identify underlying intents and patterns (800);
b. aggregating similar user requests based on identified intents to form consolidated demand profiles (802);
c. employing Photonic Quantum Computing to simulate various resource allocation strategies for the consolidated demand profiles, wherein each strategy is evaluated based on its potential carbon efficiency and ability to meet the predicted demand (804);
d. generating a carbon efficiency score for each simulated resource allocation strategy, utilizing a predefined scoring algorithm that assesses the expected carbon footprint associated with implementing each strategy (806);
e. selecting the resource allocation strategy with the highest carbon efficiency score for execution, ensuring that resources are allocated in a manner that optimizes environmental sustainability while fulfilling user demands (808);
f. dynamically adjusting the selected resource allocation strategy in real-time based on continuous monitoring of actual user activity and system performance, to accommodate unforeseen changes in demand or system capacity (810);
g. implementing the selected resource allocation strategy across the computing environment, directing resources such as processing power, memory, and network bandwidth to user requests in accordance with the strategy (812);
h. utilizing feedback loops to collect performance data on the implemented resource allocation strategy, including user satisfaction metrics and environmental impact measurements (814);
i. refining the AI model and simulation algorithms based on the collected performance data, enhancing the system's ability to accurately predict user demands and efficiently allocate resources in future cycles (816); and
j. repeating the process in a continuous loop, allowing the system to adapt and optimize resource allocation dynamically over time, with the aim of improving service quality and reducing environmental impact (818).

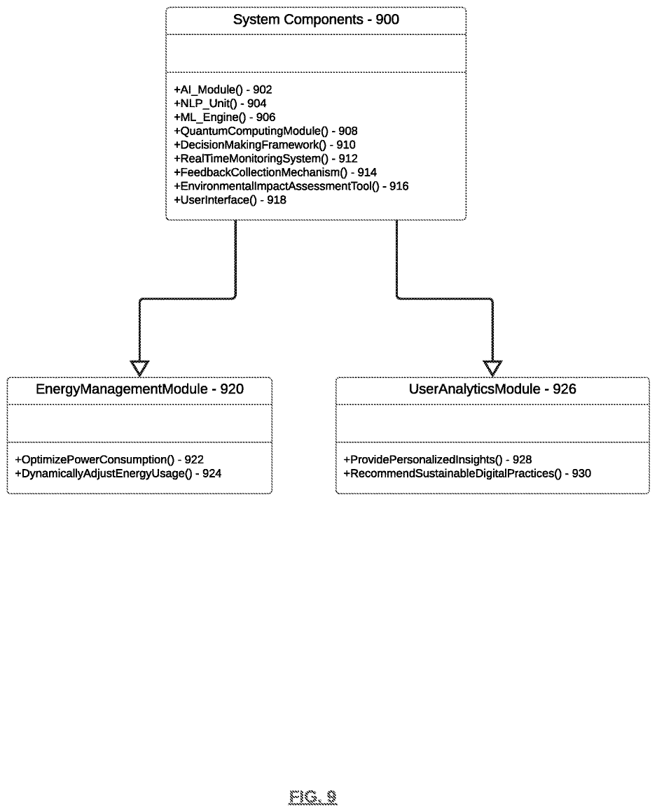

By way of non-limiting disclosure, FIG. 9 depicts a sample system flow showing sample interactions, interfaces, steps, functions, and components as they relate to resource allocation systems for carbon efficiency.

In particular, system components (or functions, modules, or the like) 900 in a system for dynamically allocating digital resources in a computing environment can include one or more of:
a. +AI_Module( ) (902): an artificial intelligence (AI) module configured to process incoming user requests to predict demands by identifying underlying intents and patterns;
b. +NLP_Unit( ) (904): a natural language processing (NLP) unit for pre-processing user requests to extract key phrases and intents;
c. +ML_Engine( ) (906): a machine learning (ML) engine that utilizes historical data to refine predictions of user demand and intent aggregation, capable of dynamic updates with new interaction data;
d. +QuantumComputingModule( ) (908): a Quantum Computing module equipped with Photonic Quantum processors to simulate and evaluate various resource allocation strategies based on carbon efficiency;
e. +DecisionMakingFramework( ) (910): a decision-making framework that selects the optimal resource allocation strategy considering carbon efficiency and user experience;
f. +RealTimeMonitoringSystem( ) (912): a real-time monitoring system for adjusting resource allocation in response to demand and system performance changes;
g. +FeedbackCollectionMechanism( ) (914): a feedback collection mechanism to gather performance data, including user satisfaction and environmental impact;
h. +EnvironmentalImpactAssessmentTool( ) (916): an environmental impact assessment tool to refine the carbon efficiency scoring of strategies;
i. +UserInterface( ) (918): a user interface that allows configuration of service delivery priorities, integrating with external databases for environmental impact metrics and utilizing distributed ledger technology for transparent logging of resource allocation decisions;
j. an energy management module (920), which can include +OptimizePowerConsumption( ) (922) and +DynamicallyAdjustEnergyUsage( ) (924), to optimize the power consumption of the computing environment, wherein the module dynamically adjusts energy usage based on the selected resource allocation strategy and current demand, aiming to further reduce the environmental impact of digital operations; and
k. a user analytics module (926), which can include +ProvidePersonalizedInsights( ) (928) and +RecommendSustainableDigitalPractices( ) (930), that leverages the AI module's data processing capabilities to provide personalized insights and recommendations for users to engage in more sustainable digital practices, thereby enhancing user engagement and promoting environmental awareness.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for dynamically allocating digital resources in a computing environment comprising the steps of:
predicting user demands utilizing an artificial intelligence (AI) model that processes incoming user requests to identify underlying intents and patterns;
pre-processing the incoming user requests using natural language processing (NLP) techniques to filter out noise and extract phrases and derived intents;
employing machine learning models trained on historical data to improve accuracy of intent prediction and demand aggregation, wherein the models are dynamically updated with new data;
categorizing the user requests into distinct groups for targeted resource allocation;
using Photonic Quantum Computing with Quantum algorithms to simulate various resource allocation strategies to identify an optimum schema, adjusting simulation parameters based on real-time feedback;
selecting a carbon-efficient strategy based on a carbon efficiency scoring algorithm;
implementing a fallback strategy for suboptimal performance;
utilizing feedback loops, including user satisfaction metrics and environmental impact measurements, to collect performance data;
refining the AI model and the simulation algorithms with the performance data;
dynamically adjusting resource allocation in response to real-time changes in demand and system capacity;
integrating environmental impact data to enhance the carbon efficiency scoring algorithm; and
providing user-configurable settings to prioritize aspects of service delivery.

2. The method of claim 1 further comprising the step of utilizing a distributed ledger technology to log and verify changes in the resource allocation and the environmental impact data.

3. The method of claim 2, wherein the distributed ledger technology facilitates real-time auditability of resource allocation decisions and the environmental impact data by stakeholders.

4. The method of claim 3, further comprising the step of utilizing a continuous optimization loop that uses genetic algorithms to evolve the resource allocation strategies based on performance feedback.

5. The method of claim 4, further comprising the step of providing a user interface that provides insights into the carbon efficiency and environmental impact of user activities.

6. The method of claim 5, further comprising the step of executing predictive maintenance algorithms to preemptively identify and address potential inefficiencies in the computing environment.

7. A method for dynamically allocating digital resources in a computing environment comprising the steps of:
predicting user demands utilizing an artificial intelligence (AI) model that processes incoming user requests to identify underlying intents and patterns;
aggregating user requests based on identified intents to form consolidated demand profiles;
employing Photonic Quantum Computing to simulate various resource allocation strategies for the consolidated demand profiles, wherein each strategy is evaluated based on its potential carbon efficiency and ability to meet the predicted demand;
generating a carbon efficiency score for each simulated resource allocation strategy, utilizing a predefined scoring algorithm that assesses an expected carbon footprint associated with implementing each strategy;
selecting the resource allocation strategy with the highest carbon efficiency score for execution, ensuring that resources are allocated in a manner that optimizes environmental sustainability while fulfilling user demands;
dynamically adjusting the selected resource allocation strategy in real-time based on continuous monitoring of actual user activity and system performance, to accommodate unforeseen changes in demand and system capacity;
implementing the selected resource allocation strategy across the computing environment, directing resources including processing power, memory, and network bandwidth to user requests in accordance with the strategy;
utilizing feedback loops to collect performance data on the implemented resource allocation strategy, including user satisfaction metrics and environmental impact measurements;
refining the AI model and simulation algorithms based on the collected performance data, enhancing system ability to accurately predict user demands and efficiently allocate resources in future cycles; and
repeating the process in a continuous loop, allowing the system to adapt and optimize resource allocation dynamically over time to service quality and reduce environmental impact.

8. The method of claim 7, further comprising the step of pre-processing incoming user requests to filter out noise and irrelevant data before predicting user demands.

9. The method of claim 8, wherein the pre-processing includes natural language processing (NLP) techniques to extract phrases and intents from user requests.

10. The method of claim 9, further comprising the step of employing machine learning models trained on historical data to improve accuracy of intent prediction and demand aggregation.

11. The method of claim 10, wherein the machine learning models are dynamically updated with new user interaction data to refine predictions over time.

12. The method of claim 11, further comprising the step of categorizing user requests into distinct groups based on the predicted intents for targeted resource allocation.

13. The method of claim 12, wherein the step of employing Photonic Quantum Computing includes using Quantum algorithms specifically designed for optimization problems.

14. The method of claim 7, including the step of adjusting Quantum simulation parameters based on real-time feedback to enhance the efficiency of resource allocation strategy simulation.

15. The method of claim 14, wherein the selection of the resource allocation strategy involves a multi-criteria decision-making process that balances carbon efficiency with user experience quality.

16. The method of claim 15, further comprising the step of implementing fallback strategies in case the primary selected resource allocation strategy fails to meet predefined performance thresholds.

17. The method of claim 16, wherein the feedback loops include user feedback on service quality, enabling direct input from users to influence future resource allocation decisions.

18. A system for dynamically allocating digital resources in a computing environment, comprising:
an artificial intelligence (AI) module configured to process incoming user requests to
predict demands by identifying underlying intents and patterns;
a natural language processing (NLP) unit for pre-processing user requests to extract phrases and intents;
a machine learning (ML) engine that utilizes historical data to refine predictions of user demand and intent aggregation, capable of dynamic updates with new interaction data;
a Quantum Computing module equipped with Photonic Quantum processors to simulate and evaluate various resource allocation strategies based on carbon efficiency;
a decision-making framework that selects an optimal resource allocation strategy considering carbon efficiency and user experience;
a real-time monitoring system for adjusting resource allocation in response to demand and system performance changes;
a feedback collection mechanism to gather performance data, including user satisfaction and environmental impact;
an environmental impact assessment tool to refine the carbon efficiency scoring of strategies; and
a user interface that allows configuration of service delivery priorities, integrating with external databases for environmental impact metrics and utilizing distributed ledger technology for transparent logging of resource allocation decisions.

19. The system of claim 18, further comprising an energy management module designed to optimize power consumption of the computing environment that dynamically adjusts energy usage based on the selected resource allocation strategy and current demand to reduce the environmental impact of digital operations.

20. The system of claim 19, further comprising a user analytics module that leverages the AI module's data processing capabilities to provide personalized insights and recommendations for users to engage in more sustainable digital practices.
